(19) United States
(12) Patent Application Publication
(10) Pub. No.: US 2008/0022644 A1
(43) Pub. Date: Jan. 31, 2008

(54) Reticulated pore formers for ceramic articles

(76) Inventor: Michael Edward DeRosa, Painted Post, NY (US)

Correspondence Address: CORNING INCORPORATED, SP-TI-3-1, CORNING, NY, 14831, US

(21) Appl. No.: 11/495,205

(22) Filed: Jul. 28, 2006

(51) Int. Cl. B01D 39/20

(52) U.S. Cl. 55/523

(57) ABSTRACT

The present invention relates to reticulated pore formers and ceramic articles including reticulated pore structures. The pore former of the present invention provides open pores having an interconnected generally three-dimensional structure and are useful in the manufacture of porous ceramic articles, such as honeycomb diesel particulate filters and catalyzed filters. The reticulated pore formers of the present invention provide controlled pore size and reticulated channel morphology in the finished ceramic articles. The pore size and the length of the pore channel may be controlled by using the desired foam structure and size. The pore formers may be mixed into a ceramic batch and extruded through a forming die resulting in a ceramic article that has semi-continuous reticulated channels throughout the entire body after firing to remove the pore former. The pore formers of the present invention are flexible and highly elastic, which inhibits rupture of the particle during the extrusion process. The use of reticulated pore formers enables the manufacture of highly permeable ceramic filters with controlled pore size distribution.

### TECHNICAL FIELD AND INDUSTRIAL APPLICABILITY OF THE INVENTION

The present invention relates to pore formers having a reticulated shape and to ceramic articles having reticulated pore structures. The current invention discloses the manufacture and use of pore formers having an open skeletal structure formed of foam fragments having a generally three-dimensional structure. The pore formers of the present invention may be used in the manufacture of porous ceramic articles such as honeycomb diesel particulate filters and catalyzed filters.

### BACKGROUND OF THE INVENTION

Diesel engines provide lower emissions and increased fuel economy as compared to gasoline engines; however, environmental and health hazards are posed by diesel exhaust emissions. Diesel particulate filters control particulate emissions from diesel-powered equipment such as trucks, buses, diesel electric locomotives and generators. Diesel particulate filters control diesel particulate emissions by allowing exhaust gasses to flow through the porous ceramic walls, while any particulate is collected on the upstream side of the wall. The surface of the upstream wall may contain a catalyst wash coat of platinum (Pt), iron (Fe), strontium (Sr) or rare earth elements such as cerium (Ce) to eliminate NOₓ and other exhaust pollutants. Preferably, diesel filters have a narrow pore size distribution with an average pore size around 10-20 microns to maximize exhaust flow across the catalyzed surface of the pore. Smaller pore sizes do not allow exhaust to flow through, thus wasting valuable catalyst, while too large a pore size can negatively impact the strength of the part.

The use of the type of pore formers such as graphite or starch may improve the substrate performance. However, for catalyzed filters, it is difficult to control pore size distribution and morphology. Therefore, it is desirable to create channels of controlled size that penetrate through the web of the filter. Structured pore formers used in the past may experience several problems during processing. Plate, rod and fibrous materials that have been used as pore formers tend become oriented in the flow direction as they pass through the extrusion die under high pressure. The oriented pore formers in the preform create oriented pores in the plane of the web after burnout. Oriented pores may not be optimum for creating good particulate filters. Spherical pore formers shaped do not provide a shape that results in a desired channel pathway structure.

Foams are networks of three-dimensional cells having a generally pentagonal dodecahedron configuration. The cells of reticulated foam are made up of three structural parts: struts, nodes (intersection or nexus of the struts), and open window areas or voids. In a thermodynamically ideal foam, there are twelve planes, each having five sides. The interstices of an ideal foam form an angle of 116.56°. In manufacturing an ideal foam is typically not formed and the interstices of the struts form an angle of between about 110-120°. Reticulated cell foams are used in packaging and cushioning. Reticulated foams are also being used to create reticulated porous ceramic monolith articles used as molten metal filters and thermal insulators. This is done in a batch process, as opposed to an extrusion process, by forming the desired shape out of a reticulated foam. The foam is then coated with a ceramic slurry or paste. The composite is then fired to create a ceramic body having a reticulated ceramic network throughout the body.

### SUMMARY OF THE INVENTION

The present invention provides for the use of reticulated foam used as pore formers in ceramic articles and particularly in the manufacture of diesel particulate filters and catalyzed substrates. The reticulated foam provides controlled pore size and reticulated channel morphology in the finished ceramic articles. The pore size and the length of the pore channel may be controlled by using the desired foam structure and size. In practice, reticulated foam fragments are formed by shredding a foam material and then sieving it to retrieve the desired size fragments. The fragments are mixed into ceramic batch as the pore former and articles such as continuously extruded honeycombs for diesel filter substrates are formed. The final fired ceramic part has reticulated channels throughout the entire body but the channels may not be continuously connected.

Therefore, according to embodiments of the invention, a porous ceramic article is provided, comprising a ceramic matrix; and a plurality of pores having a reticulated shape.

According to further embodiments of the invention, a pore former is provided, comprising a first strut having first and second ends; a node at one of said ends of said first strut; and a second strut coupled to said node and positioned at an obtuse angle to said first strut.

According to additional embodiments, the invention is a ceramic green body, comprising a powdered ceramic material precursor; a liquid; an organic binder; and a pore former having a reticulated shape.

Yet further, according to another aspect of the invention, a method of manufacturing a ceramic body is provided, comprising the steps of forming a plasticized batch including a reticulated foam pore former, and extruding said batch to form a green body article.

### BRIEF DESCRIPTION OF THE DRAWING

FIG. 1 is an optical photomicrograph of the cell structure of reticulated polymer foam.

FIG. 2A is an optical photomicrograph of the reticulated pore former of the present invention produced by grinding.

FIG. 2B is an optical micrograph showing reticulated pore formers with the smaller fragments removed after sieving.

FIG. 3A is an optical photomicrograph of a cross-section of the webs of a ceramic green body having reticulated pore formers.

FIG. 3B is an optical photomicrograph of a cross-section of the webs of a fired ceramic having a reticulated pore structure.

FIG. 3C is an optical photomicrograph of a cross-section of the webs of another embodiment of fired ceramic having a reticulated pore structure.

FIG. 3D is a three dimensional image showing the ceramic solid portion of a web taken from a fired honeycomb filter that had reticulated pore former fragments in it. The x-direction is direction across the web. The z-direction is the extrusion direction used to make the part.

FIG. 3E is a three dimensional image showing the void space of the pores in a portion of a web taken from a fired honeycomb filter that had reticulated pore former fragments in it. It is the negative image of FIG. 3C. The z-direction is the extrusion direction.

FIG. 4 is a graph of log differential pore volume versus pore size diameter (um).

FIG. 5 is a graph of cumulative pore volume (ml/g) versus pore size diameter (um).

### DETAILED DESCRIPTION AND PREFERRED EMBODIMENTS OF THE INVENTION

The present invention provides for the formation of a controlled pore size and reticulated channel morphology by the use of reticulated foam used a pore former in ceramic articles. According to certain embodiments, a bulk foam material is processed (e.g., ground, shredded or cut, for example) to a desired size, the resulting fragments are incorporated into ceramic batch, and a ceramic article is formed. One preferred method of forming the ceramic articles is by continuous or substantially continuous extrusion. One preferred ceramic article is a honeycomb shaped monolith used for use as a diesel particulate filter.

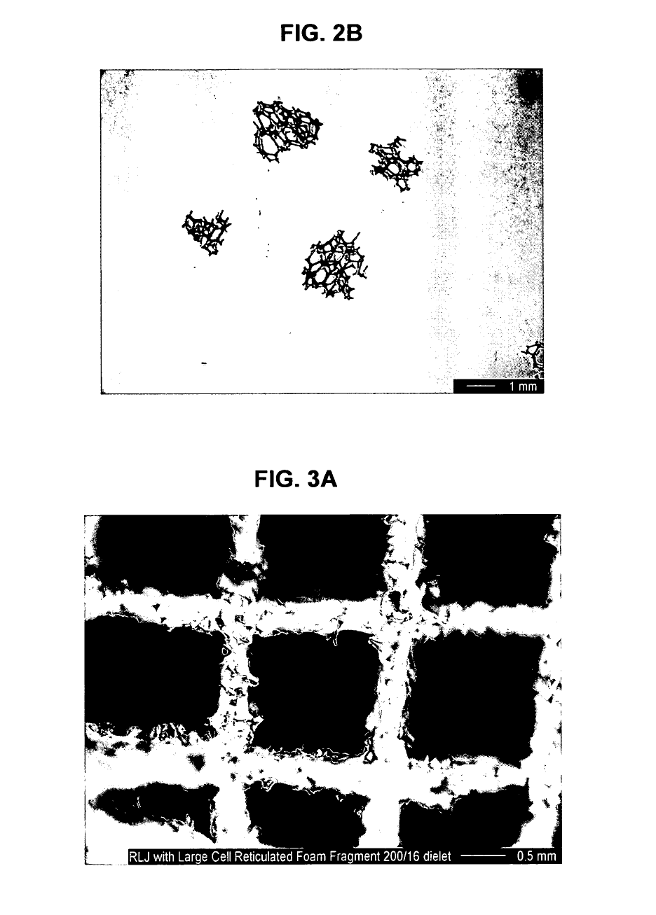

The reticulated pore former preferably has a three-dimensional structure. The reticulated pore former may be formed by grinding, grating, or shredding a block of flexible reticulated polymer foam at a temperature which is below the polymer's glass transition temperature. Typical polymer materials used to make the reticulated foam are either polyether or polyester urethane, for example. The resulting three-dimensional fragments (see FIG. 2B) typically include two struts that lie in a common plane, and often, additional struts, which lie outside of the common plane. The adjacent struts typically have a triangular cross-section and form an included angle of between about 110-120° relative to each other. The shape of the reticulated pore former unit cell is a dodecahedron which is an open skeletal structure. The pore former is made or processed by, for example, milling, grinding, shredding, cutting or chopping to form a reticulated foam fragment particle of any desired size, a size of between about 250 microns and about 1000 microns has been found to be especially useful for diesel filters having a cell wall thickness in the range of 250-500 microns.

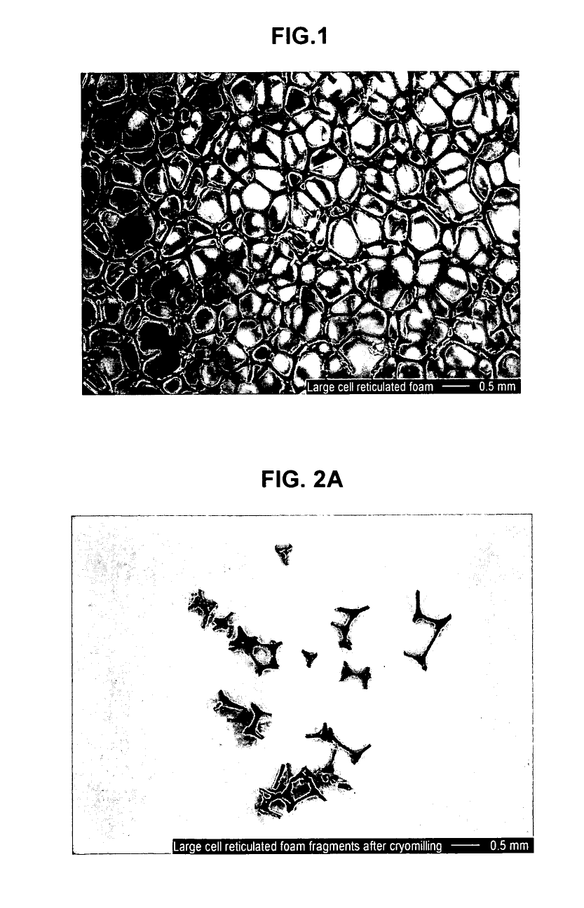

The reticulated pore formers of the present invention are typically obtained from comminuting a reticulated packing foam material, as shown in FIG. 1. The foam material may be comminuted by milling, grinding, chopping, grating, shredding or other suitable processing method. Due to the flexibility of the foam it may be preferred to freeze the polymer, for example, by immersing the foam into liquid nitrogen prior to comminution. FIG. 2A shows the fragments of foam resulting from the comminution step. As shown in FIG. 2B, these fragments are sifted or sieved through a series of screens to segregate the preferred particle sizes. Other techniques, such as air filtration may be used to provide improved particle size distribution of the reticulated pore former shape and size. Any other suitable separation techniques may be employed. FIGS. 2A and 2B show the fragments generated as a result of the cryo-grinding process. Most of the fragments generated have a three dimensional structure with various shapes and sizes. Some of the pieces resulting from the comminution step are ball shaped nodes or rod-shaped individual struts, which are not the preferred 3D structure and may be removed by screening.

The reticulated pore former is mixed into a powdered ceramic precursor dry batch. The powdered ceramic materials may be any material useful for forming a ceramic matrix material. The ceramic matrix may be selected from the group consisting of cordierite, aluminum titanate, silicon carbide, mullite, silicon nitride and other porous refractory materials. One suitable batch is that used to make cordierite (See Table 1 below) is mixed with up to 30% by volume of the final paste of the reticulated pore former of the present invention along with other processing aids, such as an organic binder and/or a surfactant and/or lubricant. The pore former is preferably mixed into dry batch, and then mixed with the liquids to form a wet batch. The wet batch is then plasticized by high shear mixing and subsequently compressed and de-aired. The plasticized mixture is then formed into a ceramic green body of any desired shape by any suitable ceramic method.

TABLE 1

| Material | Weight (grams) |
|---|---|
| Talc | 154 |
| Clay | 159 |
| Alumina | 64.5 |
| Silica | 7.7 |
| Methylcellulose binder | 25 |
| Oil | 32.5 |
| Fatty Acid | 4.1 |
| Reticulated foam pore former | 115.4 |
| Water | 190 |

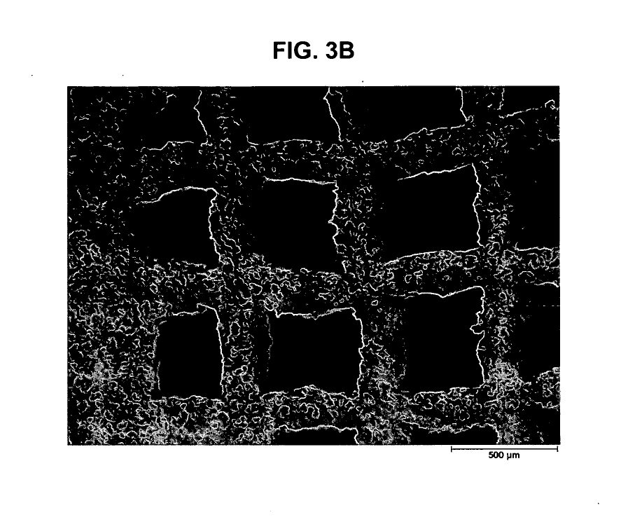

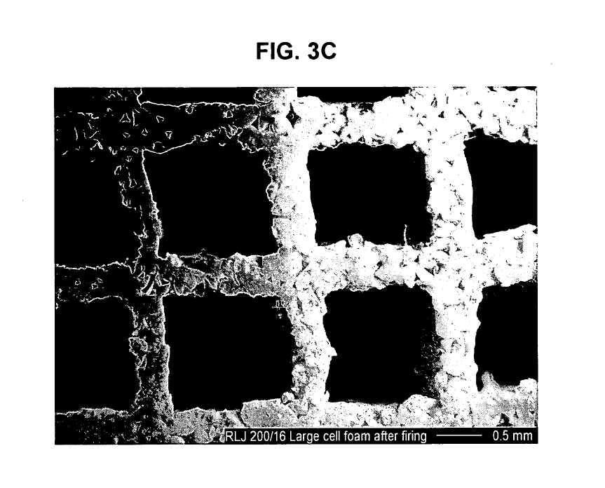

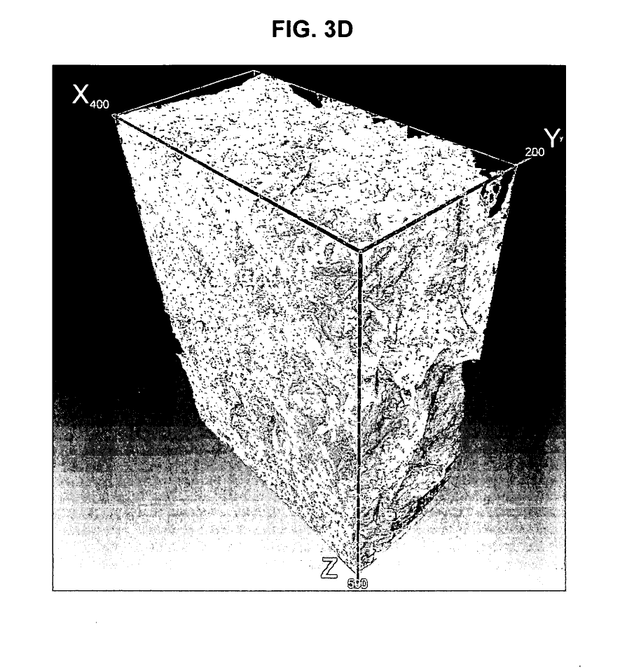

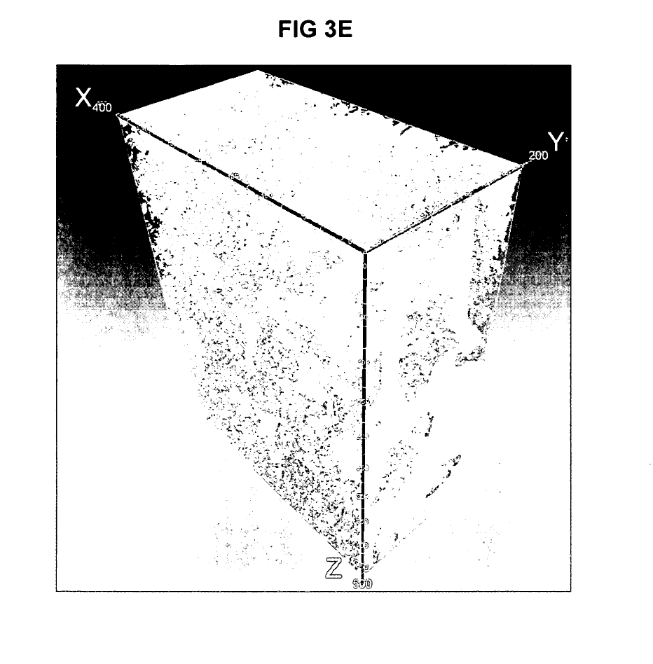

One especially suitable forming process is extrusion. In forming an extruded honeycomb article, the plasticized batch including the reticulated pore former may then be extruded, either by a ram process, single or twin screw extruder, through a honeycomb die to form a honeycomb article. The article may then be fired and plugged by conventional methods to form a diesel particulate filter. A diesel particulate filter includes a number of webs as shown in FIG. 3A and FIG. 3B and FIG. 3C. The webs preferably have a thickness in the range of about 10-30 mils and cell density of between about 100-400 cells/in².

The three dimensional nature of the foam fragment skeleton inhibits preferential alignment of the pore former along the flow direction during extrusion. During the mixing and extrusion steps, the structure of the reticulated pore former causes the pore former to tumble but maintains a random disposition with the struts pointing in random directions. Therefore, when the green body of the ceramic article is formed the pore former particles, if large enough, can span from one side of a web to the other. The green body is fired to form a fired ceramic article using a conventional ceramic firing cycle. The heat of the firing step will burn out the pore former leaving a reticulated channel through the web that allows exhaust gasses to flow from one side of a web to the other. Foams having various cell sizes and strut thicknesses are available from foam manufacturers such as Foamex and Crest Foam Industries. Reticulated cell sizes are typically reported in pores per inch (PPI). The higher the PPI value the thinner the dimensions of the struts, and closer packed the overall reticulated network is. For diesel filter applications it is preferred we use as fine a foam as possible with a size of 40-110 PPI, or even 80-110 PPI, or even 100 PPI or greater.

A green honeycomb extrudate including the reticulated pore former was examined under a stereo microscope. FIG. 3A shows a front view of the webs of the formed green body. FIG. 3B shows a front view of the webs of the honeycomb of the ceramic article after firing. This ceramic article was produced using about 20% by weight of the dry organics of a fine (approx. 110 PPI reticulated foam). As can be seen in FIG. 3A, the reticulated pore former protrudes from the surface of the webs on either side perpendicular to the plane of the webs illustrating that the pore former is orthogonal to the direction of the extrusion. This orthogonal orientation is possible under the shear forces experienced during extrusion. The protrusions also show that the structure of the pore former is not destroyed during the mixing, plasticizing and extrusion steps. FIG. 3C illustrates a frontal view showing the webs of a fired ceramic article using about 30 wt. % of a coarse (approx. 50 PPI) reticulated foam.

### EXAMPLES

An example of the benefit of reticulated pore formers of the present invention is shown in the following examples. The pore former is incorporated into a ceramic batch, the batch was extruded and fired and subsequently the pore size distribution was measured by mercury porosimetry.

In preparing the following examples, a bulk reticulated foam material was cryo-ground when the bulk foam was immersed in liquid nitrogen for 15-20 seconds and then placed in a food processor fixed with a fine blade grating plate. The size of the foam used was 110 open cell pores per linear inch (PPI). The fragments were then sifted through a coarse screen (10 mesh) and then a fine screen (80 mesh) to remove the very large (greater than 2 mm) and very small (less than 170 microns) fragments to segregate the preferred particle sizes (approximately 1900-200 microns).

A cordierite ceramic batch material was prepared with the composition shown in Table 1. The pore former, constituting approximately 30% by volume of the final dried green body, was mixed into the dry batch with a turbula mixer for 20 minutes. The liquids were added to the dry blend in a muller to mix and shear the batch into a plasticized batch for approximately 20 minutes. The plasticized batch was then loaded into a small hydraulic ram to be compressed and de-aired. The compressed, de-aired plasticized batch was extruded through a diesel honeycomb die having approximately 200 cells per square inch and a web thickness of 16 mils (0.406 mm) to form a green body honeycomb article. The extruded green body article was dried in a hot air oven at 90° C. for 3 days and then fired in a kiln with a schedule of 60° C./h up to 1400° C. where it was held for 15 h. The ware was then cooled at a rate of 200° C./h back to room temperature. FIG. 3B shows a front view of the open webs of the fired honeycomb structure.

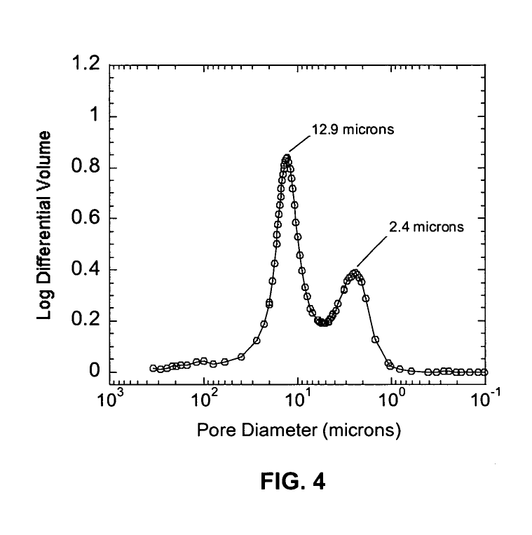

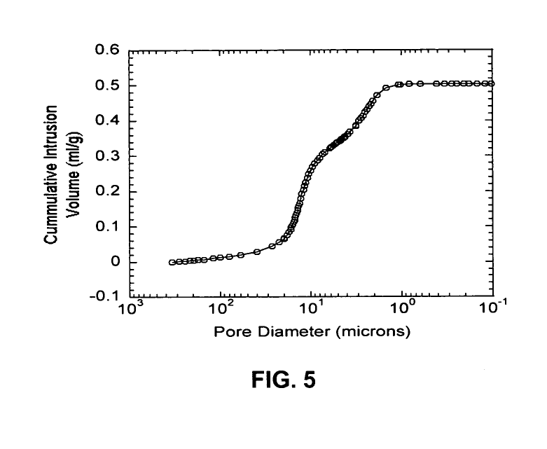

The cordierite honeycomb material was tested to determine pore size distribution. FIG. 4 shows a graph of log differential pore volume versus pore size diameter (um). FIG. 4 shows a bimodal pore size distribution with modes at 12.9 um and 2.4 um. The mode at 12.9 microns is due to the reticulated pore former. The mode at 2.4 microns is due to the inherent porosity of the cordierite body based on the composition of the inorganic components. FIG. 5 shows a graph of cumulative pore volume (ml/g) versus pore size diameter (um).

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

What is claimed is:

1. A porous ceramic article, comprising:
a ceramic matrix; and
a plurality of pores having a reticulated shape.

2. The porous ceramic article of claim 1, wherein said pores have a generally triangular cross section.

3. The porous ceramic article of claim 1, wherein said reticulated shape is a portion of a generally dodecahedron shape.

4. The porous ceramic article of claim 1, wherein said reticulated shape includes generally dodecahedronal shapes.

5. The porous ceramic article of claim 1, wherein said reticulated shape comprises:
at least three channels; and
at least two nodes positioned between said channels, wherein at least two of said channels lie substantially in a common plane.

6. The porous ceramic article of claim 1, wherein said ceramic matrix is selected from the group consisting of cordierite, aluminum titanate, silicon carbide, mullite, silicon nitride and other porous refractory materials.

7. A pore former, comprising:
a first strut having first and second ends;
a node at one of said ends of said first strut; and
a second strut coupled to said node and positioned at an obtuse angle to said first strut.

8. A pore former of claim 7 wherein said pore former is a three dimensional open skeletal structured polymer foam made of polyester urethane or polyether urethane.

9. A pore former of claim 8 wherein said pore former is created by making fragments of pore former by first reducing a temperature of the polymer foam below a glass transition temperature of the foam to make it brittle, then shredding, grating, grinding, pulping, chopping or milling to create a distribution of pore former fragments.

10. The pore former of claim 9, wherein the pore former fragments are separated using screens to obtain fragment sizes between about 250 microns (60 mesh screen) and about 1900 microns (10 mesh screen).

11. The pore former of claim 7, further comprising:
a second node; and
a third strut.

12. The pore former of claim 7, further comprising:
a second node coupled to said second strut, opposite said first node; and
a third strut coupled to said second node, said third strut lying outside said plain.

13. The pore former of claim 7, wherein said pore former is in the shape of a dodecahedron.

14. The pore former of claim 7, wherein said struts have a generally triangular cross-sectional shape.

15. The pore former of claim 7, further comprising PPI between 40 and 110.

16. The pore former of claim 15, further comprising PPI between 80 and 110.

17. A ceramic green body, comprising:
a powdered ceramic material precursor;
a liquid;
an organic binder; and
a pore former having a reticulated shape.

18. The ceramic green body of claim 17, wherein said reticulated shape is a generally a complete skeletal dodecahedron shape or portion of one or more than one complete dodecahedron shapes.

19. A method of manufacturing a ceramic body, comprising the steps of:
forming a plasticized batch including a reticulated foam pore former, and
extruding said batch to form a green body article.

20. The method of claim 19, further comprising the steps of:
extruding said batch to form a honeycomb green body article.
